(19) United States
(12) Patent Application Publication
(10) Pub. No.: US 2024/0053713 A1
(43) Pub. Date: Feb. 15, 2024

(54) Controller, Telematics Control Device and Method

(71) Applicant: Bayerische Motoren Werke Aktiengesellschaft, Muenchen (DE)

(72) Inventors: Omid Pahlevan Sharif, Bad Homburg (DE); Christian Arendt, Muenchen (DE); Peter Fertl, Muenchen (DE); Markus Wudy, Oberschleissheim (DE); Andreas Dirschl, Reichertshausen (DE); Markus Kaindl, Neubiberg (DE)

(21) Appl. No.: 18/260,015

(22) PCT Filed: Feb. 22, 2022
(86) PCT No.: PCT/EP2022/054329

§ 371 Date: Jun. 29, 2023

(30) Foreign Application Priority Data
Feb. 22, 2021 (DE) 10 2021 104 153.8

(51) Int. Cl. G05B 15/02

(52) U.S. Cl. CPC G05B 15/02

(57) ABSTRACT

A controller for a vehicle includes a main control unit, at least one first secondary control unit, and a switching device. The main control unit is configured to execute processes of critical or safety-related applications. The at least one first secondary control unit is configured execute agile applications. The switching device is configured to deactivate the at least one secondary control unit. The main control unit is also configured, in the event of the occurrence of a predefined safety-related event, to deactivate the at least one secondary control unit by means of the switching device.

The present application is the U.S. national phase of PCT Application PCT/EP2022/054329 filed on Feb. 22, 2022, which claims priority of German patent application No. 102021104153.8 filed on Feb. 22, 2021, which is incorporated herein by reference in its entirety.

### TECHNICAL FIELD

The present disclosure relates to a controller comprising a main control unit and at least one secondary control unit, and furthermore to a telematic control unit and to a method for operating a control device.

### BACKGROUND

State-of-the-art motor vehicles are frequently equipped with a plurality of networking technologies. These permit, for example, the connectivity of the vehicle with the outside world via a cellular network, or V2X (vehicle-to-X) communication, for example with the user, via Bluetooth or Wi-Fi or, for example, the location of the vehicle by means of a GNSS. The telematic control unit (TCU) represents the central connectivity gateway, and executes functions such as, for example, remote services, real time traffic information, etc. Moreover, the eCall functionality is executed via the TCU, a functionality which, in some areas of the law, is relevant for approval purposes.

As any modification to the telematic control unit can result in additional complexity of certification, this is avoided insofar as possible, once the successful certification of components is complete. As a consequence, however, any development of components must be defined and implemented at a very early stage, wherein subsequent modifications can result in high levels of additional complexity.

Various categories of functions (e.g. software) in electronic control devices are known, and can be subdivided e.g. into two main categories. The first category includes safety-related and certification-related components (e.g. critical components of the control device, e.g. for the execution of safety-critical functions, e.g. eCall or V2X functions), and the second category includes other applications (e.g., agile components, e.g., remote services or entertainment apps, for example for the execution of functions which have no significant influence upon the functional safety of the vehicle).

In general, it is endeavored to define, test and certify critical components at an early stage. At the same time, however, a common objective is the progressive modification and further development of agile components, even at a later stage (e.g., in order to permit compatibility with rapidly-developing CE (consumer electronics) technologies. However, these two objectives are mutually conflicting. Accordingly, the updating or modification of agile components at a later data cannot be executed without the further testing and certification of critical components.

In order to resolve this issue, a separation of both types of components can be employed, for example, in different control devices. In an existing control device, safety-related and certification-related components (e.g., critical components) are embodied separately from other components (e.g., agile components), either by means of software solutions or hardware solutions.

For separation at software level, for example, virtualization solutions can be employed, including the employment of virtual machine monitors and hypervisors. However, although these can be cost-effective, as both types of software components (e.g., critical components and agile components) can be run on a common hardware and chip, a design of this type can only contingently reduce the risk of recertification or delta certification.

At hardware level, various potential options for a solution are available. For example, critical components can run on a separate application processor. However, the associated costs and complexity, together with the requisite component size for this purpose, are greater, and recertification or delta certification cannot be reliably precluded in this manner, as any software modification on an external application processor might potentially disturb the function of critical software on a main processor.

Although separation at PCB (printed circuit board) level is possible, either in the same control device or in different control devices, this would also generate higher costs. Separation at ECU level is also possible. To this end, for example, applications might be partitioned on different control devices, or a new and additional control device might simply be developed. For example, remote services might be embodied on a first control device (e.g. a gateway control device), and entertainment components might be embodied on a second control device (e.g. a head unit). However, it is not always appropriate for applications to be displaced from one control device to another, and this is fundamentally contrary to the principle of high-level integration (minimization of the number of control devices).

### SUMMARY

The object of the present disclosure is therefore the provision of improved concepts for control devices, particularly telematic control units for vehicles.

This object is fulfilled by the subject matter of the independent patent claims. Further advantageous embodiments are described in the dependent claims and in the description, and are described in conjunction with the figures.

Correspondingly, a controller comprising a main control unit and at least one first secondary control unit is proposed. The controller further comprises a switching device for deactivating the at least one first secondary control unit. The main control unit is designed, in the event of the occurrence of a predefined event, to deactivate the at least one secondary control unit, by means of the switching device.

The main control unit can be designed, for example, to execute processes for critical applications (e.g. applications which are subject to mandatory approval). Conversely, the secondary control unit can be configured, for example, for the execution of agile applications (e.g. such applications which do not require authorization from an official authority). As a result of communication between the main control unit and the secondary control unit, in some situations, the secondary control unit can nevertheless exert an influence upon the main control unit.

In order to prevent a potential influence of this type in critical situations (for example, in the event of the occurrence of a predefined event which requires the reliable execution of a critical function), the secondary control unit can be deactivated, if required. The predefined event can include, e.g. a requirement for the execution of the eCall function of the controller. By means of deactivation, it can thus be prevented e.g. that any exchange of information occurs between the main control unit and the secondary control unit. In the deactivated state of the secondary control unit, it can be possible for the controller to function in the manner of a system which comprises the main control unit only, but not the deactivated secondary control unit. In other words, the switching device can be employed to execute a switchover between two functional systems of the controller (e.g. a first functional system incorporating the secondary control unit and a second functional system without the secondary control unit). It can thus be possible for the controller to be certified with the main control unit only, and for further modifications to be executed on the secondary control unit thereafter, given that the latter can be deactivated in response to the occurrence of critical events, and will then e.g. have no influence upon the certified system component comprising the main control unit.

For example, it can be provided that the switching device is configured for the electrical interruption of a connection between the main control unit and the at least one secondary control unit. The main control unit is thus designed, for the deactivation of the secondary control unit, to execute the electrical interruption of the connection to the secondary control unit by the corresponding actuation of the controller. One advantage of the interruption (e.g. physical interruption) of the connection as a means of deactivating the secondary control unit can be a particularly reliable deactivation of the secondary control unit. For example, further to the interruption of the connection (e.g. by means of a switch, e.g. a semiconductor switch), no further connection between the main control unit and the secondary control unit is in place, such that, when the secondary control unit is deactivated, a signal flux from the secondary control unit to the main control unit is not possible. According to one exemplary embodiment, the switching device can be configured in the main control unit in an integrated manner. As a result, an even more reliable interruption of the electrical connection is possible (e.g. by a simple actuation of the switching device by means of the main control unit).

For example, it can be provided that the main control unit is configured, for the deactivation of the secondary control unit, to interrupt a process which is running on the at least one secondary control unit. Deactivation of this type can provide an advantage, in that it can be executed in a very simple manner (e.g. by pausing the process which is running on the secondary control unit). Moreover, for example, an element for physical disconnection can be omitted, as a result of which the controller can be embodied in a more cost-effective manner.

According to one exemplary embodiment, it can be provided that the controller comprises a second secondary control unit. The main control unit is configured, depending upon the nature of the predefined event, to deactivate only the first secondary control unit, or to additionally deactivate the second secondary control unit. For example, depending upon the nature of the predefined event occurring, in each case, only specifically secondary control units of a plurality of secondary control units are deactivated. As a result, e.g. the flexibility of the controller can be enhanced. For example, in the event of the occurrence of a first event, for the reliable execution of a corresponding critical function on the main control unit, it can be sufficient that only a first secondary control unit is deactivated whereas, conversely, in the event of the occurrence of a second event, for the reliable execution of a corresponding critical function on the main control unit, the deactivation of both (or of a plurality of) secondary control units is required. It can thus be permitted, in the event of the occurrence of a predefined event, that it is not necessary for all the agile functions of the controller to be deactivated, for example if this is not required on safety-related grounds.

For example, it can be provided that the main control unit is a first main control unit, and that the controller comprises at least one further main control unit, which assumes a lower priority level than the first main control unit. The first main control unit is configured to deactivate the further main control unit. The first main control unit can deactivate the second main control unit, e.g. in the event of the occurrence of the predefined event, e.g. in the same manner as the secondary control unit. In this manner, a hierarchy of e.g. critical functions of the main control units can be defined, wherein a reliable execution of critical functions having a higher degree of priority can be permitted with a greater degree of security.

For example, it can be provided that the first main control unit and the further main control unit are configured to respectively deactivate the at least one secondary control unit in response to different events and/or to respectively deactivate different secondary control units of a plurality of secondary control units. For example, for the reliable execution of critical functions on the various main control units, the deactivation, in each case, of a different secondary control unit (or of a different selection of a plurality of secondary control units) may be required. In other words, it can advantageously be provided that each main control unit can deactivate precisely those selected secondary control units which might impair the reliable execution of a critical function on the respective main control unit.

For example, it can be provided that the main control unit and the at least one secondary control unit are configured on a common semiconductor chip. For example, a plurality of main control units and/or secondary control units can be configured on the common semiconductor chip. The proposed system (e.g. a controller), which permits the deactivation of secondary control units and/or of a lower priority main control unit, can thus permit a greater flexibility in the system (e.g. a variation of the functions of the secondary control unit), with a simultaneous enhancement of the integration density of the system.

For example, it can be provided that the main control unit is embodied as a main processor, and the secondary control unit is embodied as a secondary processor on the common semiconductor chip. For example, it can thus be possible for the main processor to deactivate one or more secondary processors, as required (e.g. upon the occurrence of the predefined event), in order to inhibit any influence of the secondary processor upon the main processor. An element of the controller which is relevant for certification purposes can thus be directed exclusively at the primary processor.

For example, as mentioned above, it can be provided that the predefined event comprises at least one execution of an emergency call function (e.g. eCall (emergency call) function), or an execution of a vehicle-to-X communication function. Critical functions of a vehicle of this type can require a particularly reliable functionality. For example, the element of the controller which remains active further to the deactivation of the secondary control unit can be correspondingly certified, such that evidence of a reliable functionality can be provided in accordance with regulations in force.

One aspect of the disclosure relates to a telematic control unit for a vehicle. The telematic control unit is configured to control cellular connections of the vehicle for the execution of critical vehicle functions. The telematic control unit comprises a controller, as described heretofore or hereinafter. A telematic control unit of this type can provide an advantage, in that critical functions of the telematic control unit can be defined, implemented and established at a first time point, whereas agile functions of the telematic control unit, independently of critical functions, can also be modified or added subsequently to the first time point, without influencing critical functions.

One aspect of the disclosure relates to a method for operating a controller having at least one main control unit and a secondary control unit. The method comprises an actuation of the secondary control unit, by means of the main control unit, for the execution of a secondary process on the secondary control unit, wherein the secondary process can impact upon a performance of the main control unit. The method further comprises a reception of a command for the execution of a main process on the main control unit, wherein the main process assumes a higher priority or safety level than the secondary process. The method further comprises a deactivation of the secondary control unit further to the reception of the command for the execution of the main process, in order to prevent any impact of the secondary control unit upon the main control unit during the execution of the main process.

Further details and aspects are mentioned in conjunction with the exemplary embodiments described heretofore or hereinafter (e.g. the controller). The exemplary embodiment described can comprise one or more optional additional features which correspond to one or more aspects which are mentioned in conjunction with the proposed concept or with one or more of the exemplary embodiments described heretofore or hereinafter.

### BRIEF DESCRIPTION OF THE DRAWINGS

Exemplary embodiments are described in greater detail hereinafter with reference to the attached figures. In the figures:

FIG. 1 shows a schematic example of a controller having a main control unit and a secondary control unit;

FIG. 2 shows a schematic example of a controller in a telematic control unit; and

FIG. 3 shows a flow diagram of a method for operating a controller.

### DETAILED DESCRIPTION

Various exemplary embodiments will now be described in greater detail with reference to the attached drawings, in which a number of exemplary embodiments are represented. In the figures, representation of the dimensional thicknesses of lines, layers and/or regions may be exaggerated, in the interests of clarity. In the following description of the attached figures, which represent only a number of exemplary embodiments, the same reference numbers may identify identical or comparable components.

The description of an element as “connected” or “coupled” to another element can signify that the former is directly connected or coupled to the other element, or that other elements are present therebetween. Unless defined otherwise, all the concepts employed herein (including technical and scientific concepts) will have the same meaning as that which would be assigned thereto by an average person skilled in the art, in the field in which the exemplary embodiments are included.

If the execution of modifications to certified control devices is intended, a complete recertification of the control device will generally be required. Various options are available for the separation of functions which, in part, will eliminate the necessity for any further certification of all functions or parts of a control device. As the effectiveness of software solutions, in part, is not susceptible to improvement, and separation at PCB and ECU level can generate high costs, separation at chip level represents a preferred solution. However, it may be necessary to minimize the risk of any cross-influence of less critical functions (e.g. agile software components) upon critical functions (e.g. critical components). Concepts for this purpose are described hereinafter.

FIG. 1 shows a schematic example of a controller 10 having a main control unit 11 and a secondary control unit 12. A switching device 13 is designed to deactivate the secondary control unit 12. The main control unit 11 is designed, upon the occurrence of a predefined event, to deactivate the at least one secondary control unit 12 by means of the switching device 13.

By the option for the deactivation of elements of the controller 10 as required (e.g. in the event of the occurrence of specific events which require the execution of safety-related or safety-critical functions), it is possible to ensure that these elements can have no further influence upon the controller 10. For example, the secondary control unit 12 can be switched off, if required, such that a remaining and active part of the controller 10 can execute functions, with no interference from functions on the secondary control unit.

By the option for separation, it is possible that only that part of the controller 10 which is not deactivated (e.g. is not configured to be deactivated) is required to function in a particularly reliable manner (e.g. is subject to certification). As this part can function as a standalone system, conversely, modifications can be executed, as required, on the secondary control unit 12 which is subject to deactivation, e.g. without the necessity for the recertification of the entire system, i.e. of the entire controller 10 (e.g. functions can be provided on the secondary control unit 12 which are not safety-related in a vehicle having the controller 10).

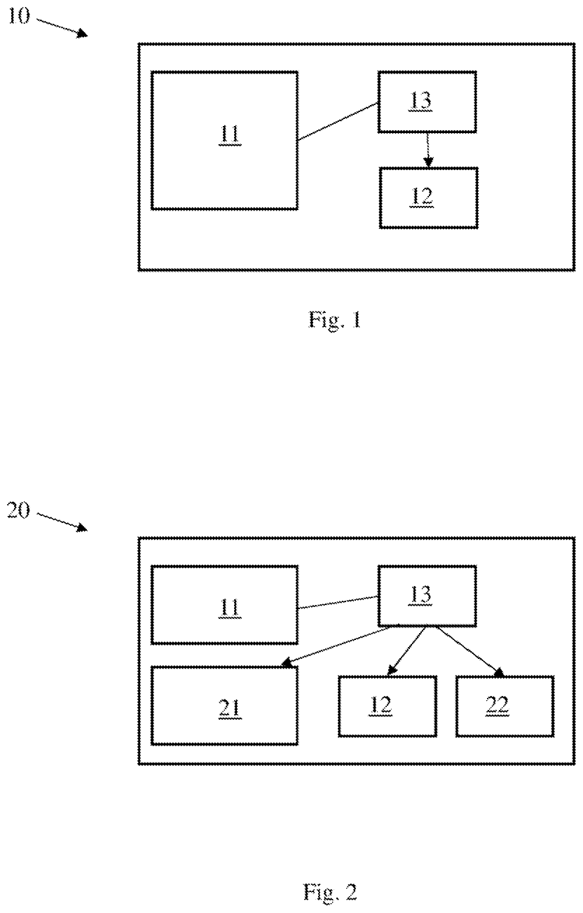

FIG. 2 shows a schematic example of a controller 10 in a telematic control unit 20 for a vehicle. In the controller 10, in addition to the first main control unit 11 and the first secondary control unit 12, a further main control unit 21 and a further secondary control unit 22 are also represented. The first main control unit, by means of the switching device 13, can deactivate one of more of the first secondary control unit 12, the further secondary control unit 22 or the further main control unit 21. It is also possible that the further main control unit 21, as required, can correspondingly deactivate the first and/or the further secondary control unit 12, 22.

By the separation of agile and critical components, e.g. at chip level, the proposed concept permits a reduction of the risk of any cross-influence of agile components upon critical components, thereby enhancing safety, and additionally reducing hazards and risks. Additionally, the risk of any delta certification or recertification can thus be further reduced. The proposed concept comprises e.g. a function in the main processor (e.g. the main control unit) which can interrupt, isolate and/or, as required, shut down all further secondary processors (e.g. secondary control units) having non-critical functions. The main processor thus secures all critical functionalities, and precludes e.g. any impact thereupon of functions which are running on secondary processors. Accordingly, all modifications to these secondary processors (or, in general terms, to non-critical components of the system) are ineffective and irrelevant vis-à-vis critical functions.

Thus, during a running time of the system (e.g. in normal operation), all processors and applications can initially operate in parallel, and with no restrictions (e.g. in the absence of the occurrence of a predefined event). In the event of the occurrence of a safety-related event (e.g. a predefined event such as, e.g. an eCall or V2X event), non-relevant components are either inhibited, connections are interrupted, or electrical disconnection is executed.

An exemplary operation of the controller is described hereinafter. In normal operation, a critical application can be active on the main processor, and 1 to n agile applications can be active on each secondary processor.

Upon the detection of a safety-related event, the critical application can continue to be executed on the main processor. Conversely, e.g. on a proportion of the secondary processors, agile applications are inhibited and/or one or more other secondary processors are entirely shut down.

Further to the execution of the critical application, e.g. all components can be reactivated (e.g. the controller 10 resumes normal operation).

The concept can also be expanded to include a plurality of main processors (e.g. a first main control unit 11 and a further main control unit 21). Thus, e.g. a first main processor can be configured for the execution of a first critical application and for the deactivation of a first selection of a plurality of secondary processors. A second main processor can be correspondingly configured for the execution of a second critical application and for the deactivation of a second selection of the plurality of secondary processors. Accordingly, the proposed concept can be adapted to existing requirements in a simple manner (e.g. to include control devices other than the telematic control unit).

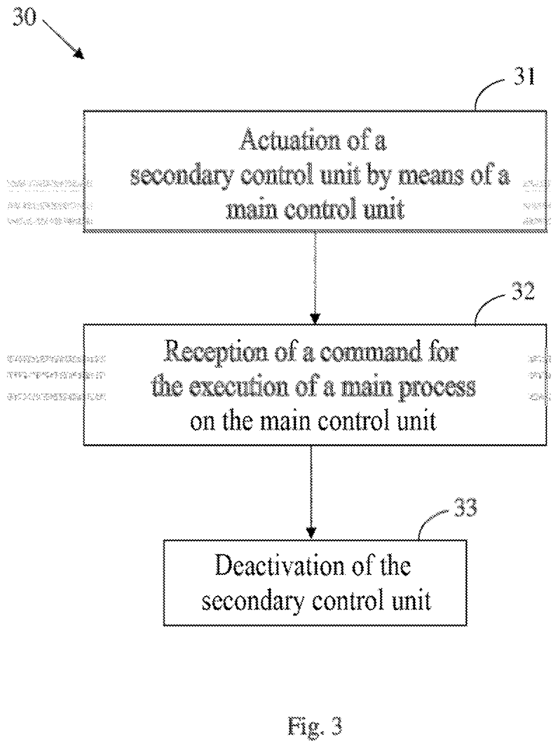

Further details and aspects are mentioned in conjunction with the exemplary embodiments described heretofore or hereinafter. The exemplary embodiment represented in FIG. 2 can comprise one or more optional additional features which correspond to one or more aspects which are mentioned in conjunction with the proposed concept, or in conjunction with one or more of the exemplary embodiments described heretofore (e.g. FIG. 1) or hereinafter (e.g. FIG. 3).

FIG. 3 shows a flow diagram of a method 30 for operating a controller, as represented e.g. in FIGS. 1 and 2. The method 30 comprises an actuation 31 of a secondary control unit, in order to execute a secondary process on the secondary control unit, wherein the secondary process can impact upon the performance of the main control unit. The method 30 further comprises the reception 32 of a command for the execution of a main process on the main control unit, wherein the main process assumes a higher priority or safety level than the secondary process. According to the method, a deactivation 33 of the secondary control unit further to the reception of the command for the execution of the main process is further provided, in order to prevent any impact of the secondary control unit upon the main control unit during the execution of the main process.

According to the proposed method, it is possible for elements of the controller to be deactivated, in the event that e.g. a key process or a key function requires the full computing capacity of the main control unit. Whereas, under normal circumstances, the main control unit can control e.g. a plurality of secondary processes (and, correspondingly, signals can be transmitted in response from the secondary control unit to the main control unit), in the event of the execution of a system-critical function, it can be necessary that no interaction with secondary processes occurs. Consequently, according to the method, the execution of such secondary processes (e.g. entertainment functions, e.g. functions for the user which are not directly associated with the driving function of the vehicle) can be inhibited, where the controller is to be employed for the execution of a main process (e.g. a safety-critical process).

Further details and aspects are mentioned in conjunction with the exemplary embodiments described heretofore or hereinafter. The exemplary embodiment represented in FIG. 3 can comprise one or more optional additional features which correspond to one or more aspects which are mentioned in conjunction with the proposed concept, or in conjunction with one or more of the exemplary embodiments described heretofore (e.g. FIGS. 1-2) or hereinafter.

One aspect relates to a modular architecture, e.g. for safety related components in highly-integrated control devices and functions. It can be possible for specific parts of a control device, as required, to be switched off or deactivated. By means of the proposed concept, an improved option is provided, wherein agile components of a system (e.g. of a control device), e.g. in a subsequent phase of development, or e.g. even thereafter, can be subject to modification or adaptation without impacting upon critical functions of the system. It can thus be prevented, for example, that it is invariably necessary to recertify the entire system or control device in the event of a modification to one part of the system or the control device.

1.-11. (canceled)

12. A controller for a vehicle, comprising:
a main control unit configured to execute processes of critical or safety-related applications;
at least one first secondary control unit configured execute agile applications; and
a switching device configured to deactivate the at least one secondary control unit,
wherein the main control unit is configured, in the event of the occurrence of a predefined safety-related event, to deactivate the at least one secondary control unit by means of the switching device.

13. The controller as claimed in claim 12, wherein:
the switching device is configured to execute an electrical interruption of a connection between the main control unit and the at least one secondary control unit; and
the main control unit is configured, for the deactivation of the secondary control unit, to electrically interrupt the connection by a corresponding actuation of the controller.

14. The controller as claimed in claim 13,
wherein the main control unit is configured, for the deactivation of the secondary control unit, to interrupt a process that is running on the at least one secondary control unit.

15. The controller as claimed in claim 12,
wherein the main control unit is configured, for the deactivation of the secondary control unit, to interrupt a process that is running on the at least one secondary control unit.

16. The controller as claimed in claim 12, further comprising a second secondary control unit,
wherein the main control unit is configured to selectively deactivate only the first secondary control unit, or deactivate both the first secondary control unit and second secondary control unit, depending upon a nature of the predefined event.

17. The controller as claimed in claim 12, wherein:
the main control unit comprises a first main control unit and the controller further comprises at least one further main control unit having a lower priority level than the first main control unit; and
the first main control unit is configured to deactivate the further main control unit.

18. The controller as claimed in claim 17, wherein:
the first main control unit and the further main control unit are configured to respectively deactivate the at least one secondary control unit in response to different events and/or to respectively deactivate different secondary control units of a plurality of secondary control units.

19. The controller as claimed in claim 12,
wherein the main control unit and the at least one secondary control unit are embodied on a common semiconductor chip.

20. The controller as claimed in claim 19,
wherein the main control unit comprises a main processor, and the secondary control unit comprises a secondary processor on the common semiconductor chip.

21. The controller as claimed in claim 12, wherein the predefined event comprises at least one execution of an emergency call function or at least one execution of a vehicle-to-X communication function.

22. The controller as claimed in claim 12,
wherein the main control unit comprises a main processor, and the secondary control unit comprises a secondary processor.

23. The controller as claimed in claim 22, wherein:
the switching device is configured to execute an electrical interruption of a connection between the main control unit and the at least one secondary control unit; and
the main control unit is configured, for the deactivation of the secondary control unit, to electrically interrupt the connection by a corresponding actuation of the controller.

24. The controller as claimed in claim 22,
wherein the main control unit is configured, for the deactivation of the secondary control unit, to interrupt a process that is running on the at least one secondary control unit.

25. The controller as claimed in claim 22, further comprising a second secondary control unit,
wherein the main control unit is configured to selectively deactivate only the first secondary control unit, or deactivate both the first secondary control unit and second secondary control unit, depending upon a nature of the predefined event.

26. A telematic control unit for a vehicle,
wherein the telematic control unit is configured to control cellular connections of the vehicle for the execution of critical vehicle functions,
wherein the telematic control unit comprises a controller as claimed in claim 1.

27. A method for operating a controller having at least one main control unit and a secondary control unit, wherein the method comprises:
actuating the secondary control unit, by means of the main control unit, in order to execute a secondary process on the secondary control unit, wherein the secondary process can impact upon a performance of the main control unit;
receiving a command for execution of a main process on the main control unit, wherein the main process assumes a higher priority or safety level than the secondary process; and
deactivating the secondary control unit, responsive to receiving the command for the execution of the main process, in order to reduce impact of the secondary control unit upon the main control unit during the execution of the main process.

28. The method of claim 27, further comprising deactivating the secondary control unit by electrically interrupting a connection between the main control unit and the secondary control unit.

29. The method of claim 27, further comprising deactivating the secondary control unit by interrupting a process that is running on the secondary control unit.
